(19) United States
(12) Patent Application Publication
(10) Pub. No.: US 2026/0348300 A1
(43) Pub. Date: Nov. 5, 2026

(54) SYSTEM AND METHOD FOR COOLING A TURBINE AND REDUCING GREENHOUSE GAS EMISSIONS THEREFROM

(71) Applicant: Powergen Energy LLC, The Woodlands, TX (US)

(72) Inventor: Paul HOPKINS, The Woodlands, TX (US)

(21) Appl. No.: 19/743,850

(22) Filed: Jul. 16, 2026

Related U.S. Application Data
(63) Continuation of application No. 19/444,426, filed on Jan. 9, 2026.
(60) Provisional application No. 63/743,389, filed on Jan. 9, 2025.

(51) Int. Cl. F01D 25/12

(52) U.S. Cl. CPC F01D 25/12; F05D 2260/212

(57) ABSTRACT

An injection system for cooling a gas turbine or a diesel engine has a first pump adapted to pressurize a liquid passing therethrough, a heat exchanger in fluid communication with the first pump so as to elevate a temperature of the liquid, a second pump downstream of the heat exchanger adapted to increase pressure of the liquid, an injection device downstream of the second pump and having a plurality of nozzles adapted to spray the liquid into an inflow duct of the gas turbine or diesel engine, a flow control valve downstream of the second pump and upstream of the injection device and adapted to limit a volume of the liquid flowing to the injection device, and an ionizer downstream of the flow control valve and upstream of the injection device. The ionizer is adapted to impart a negative charge to the liquid.

### CROSS-REFERENCE TO RELATED APPLICATIONS

The present application is a continuation of U.S. Application No. 19/444426, filed on Jan. 9, 2026, presently pending. U.S. Application No. 19/444426 claims priority from U.S. Provisional Application No. 63/743389, filed Jan. 9, 2025.

### FIELD OF THE INVENTION

The present invention relates to the fields of gas turbines and diesel engines. More particularly, the present invention relates to the cooling of gas turbines and diesel engines. Even more particularly, the present invention relates to the field of cooling of gas turbines and diesel engines using an overspray water injection system and preventing erosion of turbine components when using such a system.

### BACKGROUND OF THE INVENTION

Gas turbines are well known and are utilized worldwide for power generation purposes. There are number of different approaches for improving the power output of a gas turbine. These include cooling of the turbine to increase power output.

Various patents were issued in the past relating to gas turbines and injection systems for cooling gas turbines. For example, U.S. Patent No. 7,784,286 (the ‘286 patent), issued on Aug. 31, 2010, to Bolis et al., discloses a wet compression method and apparatus for power augmentation in gas turbines. In this patent, a liquid droplet injection device is provided on the upstream side of the compressor for injecting liquid into the stream of intake air. This purportedly increases the shaft power generated by the gas turbine unit. An increase or decrease of the shaft power output of the gas turbine can be accomplished utilizing the system of the' 286 patent by addition or reduction of liquid droplets introduced by the liquid droplet injection device.

U.S. Patent No. 4,796,429, issued on Jan. 10, 1989, to Verdouw, describes a combustor diffuser assembly for a gas turbine engine. The assembly includes a prediffuser for receiving compressed air from a gasifier impeller of the gas turbine engine and for directing it into the inlet of a vortex control downstream diffuser. The prediffuser and vortex controller control diffuser are spaced to form gaps for air bleed to form vortices to minimize bleed and main diffuser flow pressure drop, and to minimize distortion in compressed air flow to plural passages leading to primary and secondary air openings in the inner and outer walls of an annular combustor assembly for the gas turbine engine.

U.S. Patent No. 4,478,553, issued on Oct. 23, 1980, to Leibowitz at al., describes a compression-intensified thermodynamic gas process. This patent teaches a compressor rotor having a series of passage forming blades between which a process gas is conducted during compression. A cooling metering system is contained within the rotor structure which is arranged to introduce a liquid coolant directly into the gas flow as the gas is being compressed. Coolant nozzles are strategically positioned throughout the rotor so that coolant droplets that are introduced into the flow stream will pass freely out of the rotor without impacting the rotor blades.

Current technologies for inlet cooling systems for gas turbines can be divided into several different types. Some methods of cooling involve chillers provided to cool the air inlet. However, the present invention involves water injection systems for air inlet cooling. Water injection systems can be also to be divided into at least two types: (1) water injection systems which inject up to saturation, including evaporative cooling and fogging systems; and (2) water injection systems which inject to more than saturation, or overspray systems. These overspray water injection systems can include cold water, wet compression systems, and high temperature molecular injection systems.

One high temperature molecular injection system is known as SwirlFlash® and was developed by Alpha Power Systems. This SwirlFlash® system was designed to inject superheated water (approximately 180° C) at high pressure (approximately 130 BARG) into the bell mouth of the gas turbine. In the system, the heated and pressurized water is injected through a swirl nozzle. The injected water has the shape of a cone, with droplet sizes of approximately 25 microns. However, because the water has been heated significantly above the boiling point at ambient pressure, flashing occurs upon injection. This flashing results in the 25-microns droplets exploding into tiny fragments, each having a size of approximately 2.5 microns.

Such systems which use atomized molecules are described in U.S. Patent Nos. 7,448,217 and 7,520,137. Additionally similar injection systems are described in Russian patent document 2517995C2. These high temperature molecular injection systems can be very efficient and result in increased power output from the turbine.

FIGS. 1 and 2 illustrates an atomized injection system as disclosed in U.S. Patent No. 7,520,137. Referring to FIG. 1, there is shown a gas turbine system 1. The gas turbine system 1 includes a compressor 1a, a combustor 1b and a turbine 1c. An intake region 2 is connected to the gas turbine system 1. The intake region 2 includes an inflow duct 3. Intake silencer 5 and air filter 4 are upstream of the inflow duct 3.

An injection device 6 positioned within the inflow duct 3. The injection device 6 has a plurality of nozzles thereon for injection. The injection device 6 is in fluid communication with a pump 7, such as a centrifugal pump. The pump 7 supplies cooling liquid through a valve block 8 and then on to the nozzles of the injection device 6.

Referring to FIG. 2, there is shown one example of an arrangement of nozzles on an injection device 6 of the prior art. FIG. 2 illustrates a plurality of nozzles 13 arranged in a circular manner and connected to tubes 12. As can be seen in FIG. 2, the arrangement of nozzles 13 allows for the flow of air through the inflow duct 3 and around the arrangement of nozzles 13 and tubes 12.

FIG. 3 is a schematic view of an injection system of the prior art used in the gas turbine system illustrated in the previous figures. In FIG. 3, the injection system 14 of the prior art includes a line 16 which is in fluid communication with the various components of the injection system 14. A supply of demineralized water at ambient conditions is introduced into line 16. The demineralized water is preferably at a temperature of 15 ºC (60 ºF) and a pressure of 3 Barg (44 p.s.i.g.). An initial pump 18 is connected to the line 16.

The initial pump 18 (which is not shown in the previous figures) pressurizes the demineralized water to up to 15 Barg (218 p.s.i.g.). The demineralized water is maintained at the temperature at which it was introduced (i.e. 15 ºC, 60 ºF).

A heat exchanger 20 is provided downstream of the initial pump 18. The heat exchanger 20 is connected to an outside source of heat. FIG. 3 illustrates this outside source of heat as steam or gas turbine (“GT”) exhaust. The heat exchanger 20 raises the temperature of the pressurized demineralized water from 15 ºC (60 ºF) to approximately 180 ºC (356 ºF). The now pressurized and heated demineralized water then travels through the main pump 7.

At the main pump 7, the pressure of the pressurized and heated demineralized water is raised significantly to approximately 130 Barg (1885 p.s.i.g.). The temperature is maintained. This heated and pressurized demineralized water is then delivered to the injection device 6 and sprayed via the nozzles 13 into the inflow duct 3 of the gas turbine system.

The system described in FIGS. 1-3 is very effective and increases power production from the generator by approximately 10%, which is greater than other methods of cooling. Additionally, the system of FIGS. 1-3 is relatively inexpensive to install and is operable in different types of conditions, including high humidity conditions unsuitable for evaporative cooling or fogging methods. Additionally, the system in accordance with FIGS. 1-3 can reduce NOX emissions up to 40%.

However, several problems have been identified related to use of these systems. While flashing is very effective at reducing the droplet size, the flashing increases erosion of the orifice or opening of the nozzles. This causes an increase in water supply to the turbine. Oversupply of water can cause flooding and damage to the gas turbine. The problems associated with the coalescing of water droplets, due to increased orifice size, became apparent after long-term use of the gas turbines.

Additionally, the water droplets in the system of the prior art can coalesce to form greater size droplets, leading to erosion to the leading edge of the gas turbine compression blades. Erosion leads to higher maintenance cost for the gas turbines and decreases lifetime for the gas turbines.

As such, a need has arisen to provide a solution for the erosion problem associated with high temperature molecular injection water injection systems.

It is an object of the present invention to provide a water injection system or a retrofit to a water injection system which decreases erosion of the gas turbine compression blades.

It is another object of the present invention to provide a water injection system wherein water droplets do not coalesce after being sprayed into the gas turbine.

It is another object of the present invention to limit the water supply which flows to the gas turbine in a water injection system.

It is another object of the present invention to provide a method for retrofitting a high temperature molecular injection water injection system to prevent erosion of the gas turbine compressor blades.

It is another object of the present invention to provide a water injection system for the cooling of gas turbines and diesel engines which increases the power therefrom.

It is another object the present invention to provide a water injection system for a gas turbine or diesel engine which reduces greenhouse gases associated with the gas turbine or diesel engine.

It is yet another object of the present invention to provide a water injection system for the cooling of gas turbines and diesel engines which is inexpensive to install and has low operating costs.

It is yet another object of the present invention to provide a water injection system for the cooling of the gas turbine which can operate in varying weather conditions.

These and other objects and advantages of the present invention will become apparent from a reading of the attached specification and appended claims.

### SUMMARY OF THE INVENTION

In an embodiment, the present invention is an injection system for cooling gas turbines and diesel engines. The system includes a first pump adapted to pressurize a liquid delivered to the first pump by a line. A heat exchanger is in fluid communication with the first pump. The heat exchanger is connected to a source of heat. A second pump is provided in fluid communication with the heat pump. The second pump is downstream of the first pump. The second pump is adapted to further pressurize the liquid. A flow control valve is provided in fluid communication with the second pump. An ionizing charger is in fluid communication with the flow control valve. An injection device is in fluid communication with the ionizing charger. The injection device has a plurality of nozzles adapted to spray liquid into an inflow duct of the gas turbine or diesel engine.

In a preferred embodiment, the liquid is demineralized water.

In an embodiment, a source of heat is steam or the exhaust of the gas turbine.

In an embodiment, the flow control valve limits flow of the liquid to between approximately 1% and 10% of an air mass moving through the inflow duct.

In a preferred embodiment, the flow control valve limits flow of the liquid to between approximately 1% and 3% of an air mass moving through the inflow duct.

In embodiment, the system further includes insulation joints positioned on each of the suction connection and a discharge connection of the ionizing charger.

In an embodiment, the flow control valve is pressure regulated.

In an embodiment, the first pump is adapted to pressurize the fluid to approximately 15 Barg (218 p.s.i.g.), and the second pump is adapted to pressurize the fluid to approximately 130 Barg (1885 p.s.i.g.).

In an embodiment, the heat exchanger heats the liquid to approximately 160 ºC to 200 ºC (320 ºF to 392 ºF).

The present invention is also a method of cooling a gas turbine or diesel engine having an inflow duct. The method includes pressurizing a demineralized water to approximately 130 Barg (1885 p.s.i.g.). The temperature of the pressurized demineralized water is increased to approximately 180 ºC (356 ºF). The pressurized, demineralized and heated water is flowed through a flow control valve so as to limit flow of the pressurized and heated demineralized water. The pressurized and heated demineralized water is negatively-charged and injected into the inflow duct through a plurality of nozzles.

In an embodiment, the step pressurizing includes pressurizing the demineralized water to approximately 15 Barg (218 p.s.i.g.) with a first pump; and a further pressurizing the demineralized water to approximately 130 Barg (1885 p.s.i.g.) with a second pump, wherein the step of increasing the temperature of the pressurized demineralized water is accomplished by a heat exchanger positioned between the first and second pumps.

In an embodiment, the demineralized water is heated to approximately 160 ºC to 200 ºC (320 ºF to 392 ºF).

In an embodiment, the demineralized water is pressurized to approximately 120 Barg to 140 Barg (1740 p.s.i.g. to 2030 p.s.i.g.).

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF DRAWINGS

FIG. 1 is a schematic view of a gas turbine system with a water injection cooling system of the prior art.

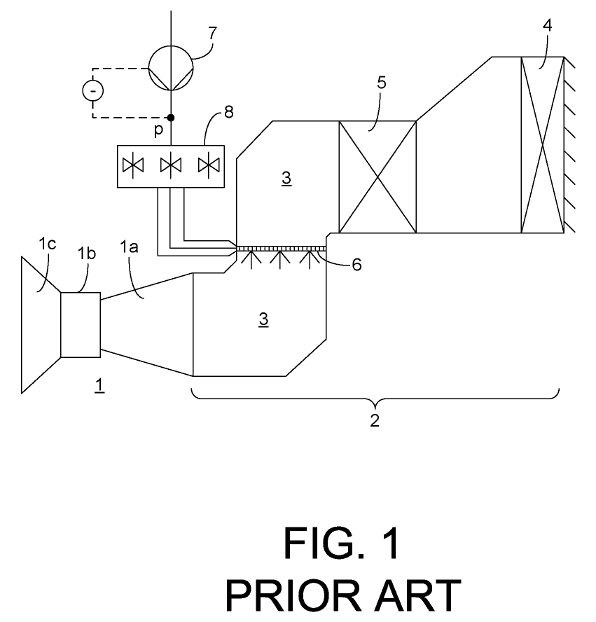

FIG. 2 is an example view of an injection device with nozzles in accordance with the prior art.

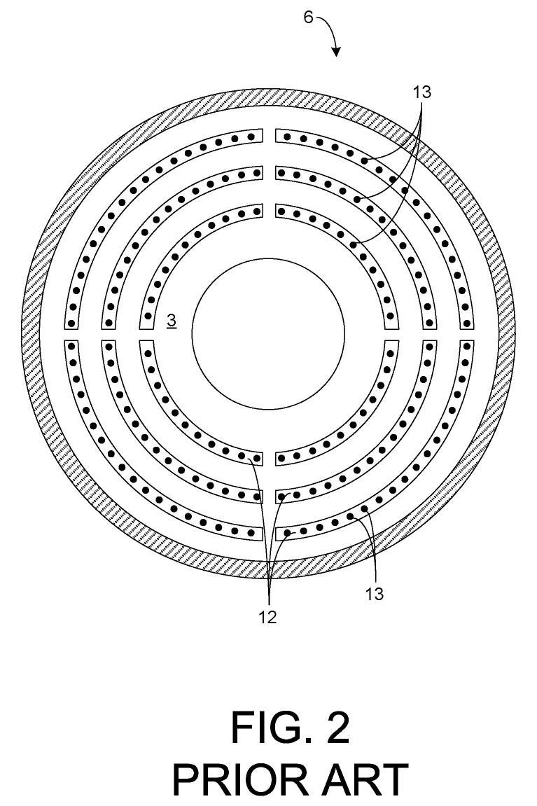

FIG. 3 is a schematic view of a particular injection system of the prior art, used in the gas turbine system illustrated in FIGS. 1 and 2.

FIG. 4 is a schematic view of the gas turbine cooling injection system of the present invention.

### DETAILED DESCRIPTION OF THE INVENTION

The system and method of the present invention are designed to inject super-heated water (approximately 180 ºC [356 ºF]) at high pressure (approximately 130 Barg [1885 p.s.i.g.]) into the bell mouth of a gas turbine or diesel engine. The outcome of this injection is an instant cooling of the air due to evaporation of water droplets, which will in turn lower their temperature and result in a high mass going to the gas turbine. This process significantly increases output power of the turbine. To prevent erosion of turbine blades and increased lifespan of the turbine, as will be discussed hereinbelow, the system includes a charging mechanism to prevent the coalescing of water droplets into water droplets of a larger size, and a flow control valve to prevent oversupply water into the gas turbine.

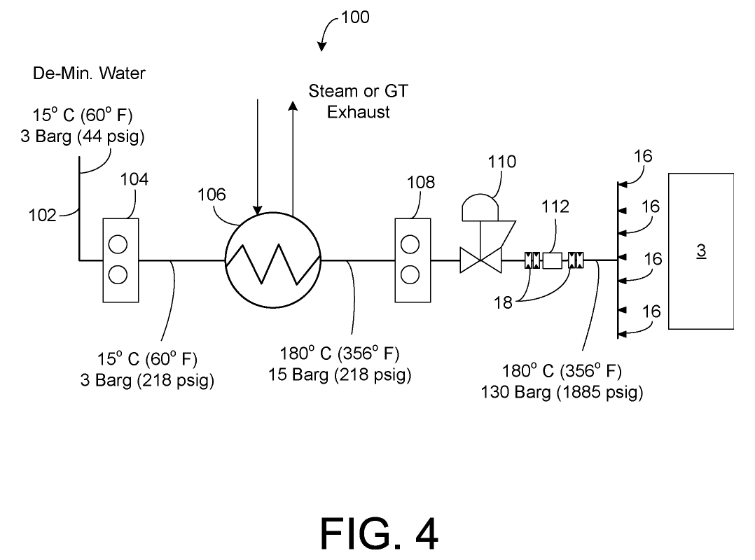

Referring to FIG. 4, there is shown the injection system 100 in accordance with the preferred embodiment of the present invention. A source of ambient condition demineralized water is provided in a line 102, which is in fluid communication with the various components of the system 100 of the present invention. This water flows within line 102 to a first pump 104. This first pump or motor 104 increases the pressure of the water to approximately 15 Barg (218 p.s.i.g.), while maintaining the initial temperature of approximately 15 ºC. In an embodiment, the first pump 104 increases the pressure of the water to approximately 13.8 Barg (200 p.s.i.g.).

From the first pump 104, the water is flowed to the heat exchanger 106. The heat exchanger 106 is connected to an outside source of heat, which is shown in FIG. 4 as steam or gas turbine exhaust. The heat exchanger 106 heats the water to approximately 180 ºC (356 ºF), while maintaining the pressure at approximately 15 Barg (218 p.s.i.g.).

The water from the heat exchanger 106 then flows to the second, main pump 108. This main pump 108 greatly increases the pressure of the heated water to approximately 130 Barg (1885 p.s.i.g.). This heating results in the water being significantly above the boiling point at ambient temperature, such that when it is introduced into the inflow duct of the gas turbine, flashing will occur. In an embodiment, the main pump 108 increases the pressure of the heated water to approximately 124.1 Barg (1800 p.s.i.g.).

From the main pump 108, the water flows through a flow control valve 110. The flow control valve 110 regulates the amount of water passing through the flow control valve 110 based on the pressure of the water. This ensures that an ideal amount of water is being introduced to the turbine and avoids issues with flooding and erosion. The flow control valve 110 limits flow of the liquid to between approximately 1% and 10% of the air mass moving through the inflow duct. Preferably, the flow control valve 110 limits flow of the liquid to between approximately 1% and 3% of the air mass moving through the inflow duct.

The water then travels toward through an ionizing charger 112. The ionizing charger 112 negatively charges the water, which will cause the water droplets to repel from each other, and the limit the chance of being bonded together (i.e. coalescing), resulting in the droplets being maintained at the 2-to-3-micron size once injected until they evaporate. Additionally, the negative charge on the water droplets prevents the droplets from accumulating on the gas turbine components and internal casing, which is another area where coalescing can take place. This is because the gas turbine components are also negatively charged.

Insulation joints 118 are provided on either side of the ionizing charger 112 and are connected to the suction and discharge connections of the ionizing charger 112.

The high-pressure, superheated water then flows to the injection device 114 and through the nozzles 116 into the inflow duct 3 of the gas turbine or diesel engine.

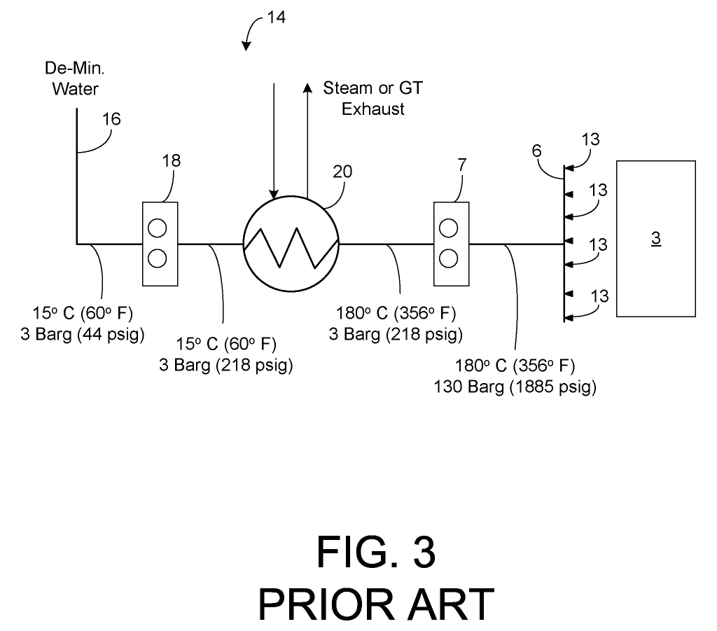

As is the case with the system shown in FIG. 3, once the water passes through the nozzles 116, flashing occurs and the water particles effectively shatter into tiny 2–3-micron sized particles in the airstream of the inflow duct 3. Because the droplets are negatively charged, they will not coalesce or accumulate on the turbine components.

While the flashing may still result in the erosion of the orifice or opening of the nozzles 116, the flow control valve 110 prevents oversupply of water to the inflow duct 3, thus reducing the chances of the 2–3-micron droplets coalescing and forming greater-sized droplets. The flow control valve 110 ensures that an ideal amount of water is delivered to the gas turbine during operation thereof over a period of time.

The system 100 of the present invention can operate within temperature ranges downstream of the main pump 108 of between 160 ºC and 200 ºC (320 ºF to 392 ºF). Additionally, the pressure downstream of the main pump 108 can be between 120 Barg and 140 Barg (1740 p.s.i.g. to 2030 p.s.i.g.).

The system of the present invention can also comprise a retrofit or a retrofit kit wherein the flow control valve 110 and ionizing charger 112 with insulation joints 118 are provided / installed in an existing system between the main pump 108 and the existing injection device 114 and nozzles 116. By retrofitting an existing system, the lifespan of the existing system can be extended and undue maintenance prevented.

The present invention is also a method of cooling a gas turbine or diesel engine, wherein the gas turbine the diesel engine has an inflow duct 3. The method includes the step of pressurizing a demineralized water to approximately 130 Barg (1885 p.s.i.g.). The temperature of the pressurized demineralized water is increased to approximately 180 ºC (356 ºF). The pressurized demineralized water is flowed through flow control valve 110 so as to limit flow of the pressurized demineralized water. The pressurized demineralized water is then negatively charged using an ionizing charger 112. Finally, the negatively charged pressurized demineralized water is injected into the inflow duct 3 through a plurality of nozzles 116.

The step of pressurizing may comprise, with a first pump 104, pressurizing the demineralized water to approximately 15 Barg (218 p.s.i.g.); and with a second pump, further pressurizing the demineralized water to approximately 130 Barg (1885 p.s.i.g.). The step of increasing the temperature of the pressurized water is accomplished by a heat exchanger 106 positioned between the first and second pumps 104 and 108. The demineralized water may be pressurized to approximately 120 Barg to 140 Barg (1740 to 2030 p.s.i.g.).

The system of the present invention accomplishes the goals of the prior art system - namely increasing power from the gas turbine - and shares several benefits therewith. These benefits include relatively inexpensive installation and operating costs, and the ability to operate in high humidity conditions. Further, the systems can reduce NOX emissions by up to 40%.

In addition to the advantages of the prior art systems, the system of the present invention extends the lifespan of the gas turbine and does not have any detrimental effect on the compression blades of the gas turbine or the inlet plenum, due to the flow control valve and ionizing charger. In addition to extending the gas turbine lifespan, the system of the present invention additionally results in a lower maintenance cost and can be retrofitted onto existing systems.

The foregoing disclosure and description of the invention is illustrative and explanatory thereof. Various changes in the details of the illustrated construction can be made within the scope of the present invention without departing from the true spirit of the invention. The present invention should only be limited by the following claims and their legal equivalents.

1. An injection system for cooling gas turbines or a diesel engine, the injection system comprising:
a first pump adapted to pressurize a liquid passing therethrough;
a heat exchanger in fluid communication with said first pump, said heat exchanger adapted to elevate a temperature of the liquid from said first pump, said heat exchanger being connected to a source of heat;
a second pump in fluid communication with said heat exchanger and downstream therefrom, said second pump adapted to increase the pressure of the liquid from said heat exchanger;
an injection device downstream of said second pump, said injection device having a plurality of nozzles adapted to spray the liquid into an inflow duct of the gas turbine or diesel engine;
a flow control valve downstream of said second pump and upstream of said injection device, said flow control valve adapted to limit a volume of the liquid flowing to said injection device; and
an ionizer downstream of said flow control valve and upstream of said injection device, said ionizer adapted to impart a negative charge to the liquid such that the negatively-charged liquid is sprayed outwardly of the plurality of nozzles of said injection device.

2. The injection system of claim 1, further comprising:
a supply of demineralized liquid upstream of said first pump, said supply of demineralized liquid being the liquid pressurized by said first pump.

3. The injection system of claim 1, wherein the source of heat is steam or an exhaust of the gas turbine.

4. The injection system of claim 1, wherein said flow control valve limits flow of the liquid between 1% and 10% of an air mass moving through the inflow duct of the gas turbine or diesel engine.

5. The injection system of claim 4, wherein the flow control valve limits flow of the liquid to between approximately 1% and 3% of the air mass moving through the inflow duct.

6. The injection system of claim 1, further comprising:
at least one insulation joint positioned on at least one of a suction connection and discharge connection of the ionizer.

7. The injection system of claim 1, wherein the flow control valve is pressure-regulated.

8. The injection system of claim 1, wherein the first pump is adapted to pressurize the fluid to approximately 200 p.s.i.g.

9. The injection system of claim 1, wherein the second pump is adapted to pressurize the fluid to approximately 1800 p.s.i.g.

10. The injection system of claim 1, wherein the heat exchanger heats the liquid to between approximately 320 ºF to 392 ºF.

11. A cooling system comprising:
a supply of a liquid;
a first pump downstream of said supply of liquid, said first pump adapted to pressurize liquid from said supply of liquid;
a heat exchanger downstream of said first pump, said heat exchanger adapted to elevate a temperature of the pressurized liquid from the first pump, said heat exchanger being connected to a source of heat;
a second pump downstream of said heat exchanger, said second pump adapted to increase a pressure of the elevated temperature liquid from said heat exchanger;
a gas turbine having an inflow duct;
an injection device downstream of said second pump, said injection device having at least one nozzle directed toward the inflow duct of said gas turbine so as to spray the increased pressure liquid from the said second pump into the inflow duct of the gas turbine;
a flow control valve downstream of said second pump and upstream of said injection device, said flow control valve adapted to limit a volume of the liquid flowing to said injection device and into the inflow duct of the gas turbine; and
an ionizer downstream of said flow control valve and upstream of said injection device, said ionizer adapted to impart a charge to the liquid from the second pump such that a charged liquid is sprayed by the at least one nozzle outwardly into the inflow duct of the gas turbine.

12. The cooling system of claim 11, wherein the source of heat is steam or exhaust from the gas turbine.

13. The cooling system of claim 11, wherein said flow control valve limits the volume of the liquid to between 1% and 10% of an air moving through the inflow duct of the gas turbine.

14. The cooling system of claim 13, further comprising:
at least one insulation joint positioned on at least one of a suction connection and a discharge connection of the ionizer.

15. The cooling system of claim 11, wherein said ionizer negatively charges the liquid.

16. The cooling system of claim 11, wherein the supply of liquid is a supply of demineralized liquid.

17. The cooling system of claim 11, wherein said first pump is adapted to pressurize the liquid to approximately at least 200 p.s.i.g., said second pump being adapted to pressurize the liquid to at least 1800 p.s.i.g., the heat exchanger heating the liquid to a temperature of between 160 ºC and 200 ºC (320° F and 392° F).

18. A method of cooling a gas turbine or diesel engine having an inflow duct, the method comprising:
pressurizing a demineralized water;
increasing a temperature of the pressurize demineralized water;
flowing the pressurize demineralized water through a flow control valve so as to limit a volume of the pressurized demineralized water;
negatively charging the pressurized demineralized water; and
injecting the negatively-charged pressurized demineralized water into the inflow duct through at least one nozzle.

19. The method of claim 18, wherein the step of pressurizing comprises:
pressurizing the demineralized water to a first pressure; and
further pressurizing the demineralized water to a second pressure, wherein the first pressure is less than the second pressure, the step of pressurizing to a first pressure is prior to the step of increasing the temperature, the step of pressurizing to the second pressure being subsequent to the step of increasing the temperature.

20. The method of claim 18, wherein the step of injecting is through a plurality of nozzles directed into the inflow duct of the gas turbine or diesel engine.
